(19) United States
(12) Patent Application Publication
(10) Pub. No.: US 2008/0113315 A1
(43) Pub. Date: May 15, 2008

(54) ELASTIC DENTAL DEVICE

(75) Inventor: Russell Beggs, Santa Cruz, CA (US)

Correspondence Address: FOLEY & LARDNER LLP, 975 PAGE MILL ROAD, PALO ALTO, CA, 94304, US

(73) Assignee: Danville Materials, Inc.

(21) Appl. No.: 11/868,007

(22) Filed: Oct. 5, 2007

Related U.S. Application Data
(60) Provisional application No. 60/849,992, filed on Oct. 6, 2006.

(51) Int. Cl. A61C 5/04; A61C 7/00

(52) U.S. Cl. 433/149; 433/148; 433/215

(57) ABSTRACT

The invention provides an elastic dental wedge for use in securing a matrix band or a cavity filling material mold against an object tooth. The dental wedge of the instant invention can be easily inserted and removed during dental treatment procedures. Also described herein are the methods of using this dental wedge in tooth restorations, orthodontic operations, etc.

### CROSS REFERENCE TO RELATED APPLICATIONS

This application claims the benefit of U.S. provisional application Ser. No. 60/849,992, filed Oct. 6, 2006 which is incorporated herein by reference.

### BACKGROUND OF THE INVENTION

1. Field of the Invention

The instant invention relates generally to the field of dentistry, and specifically to dental tools, devices and methods for using these tools. More specifically, the instant invention relates to an elastic dental wedge for use in securing a matrix band or a cavity filling material mold against an object tooth. The dental wedge can be easily inserted and removed during dental treatment procedures.

2. Description of the Related Art

In the art of dentistry, during cavity filling procedures, use of dental wedges and matrix bands is extremely common. Conventional matrix bands are essentially molds for the filling material and are typically comprised of thin curved metallic members that are placed in between two adjacent teeth. They are necessary to provide additional lateral support for the filling material when the filling material is placed on the side wall of a tooth between two adjacent teeth. The use of the matrix band allows the filling material to conform to a desired shape while maintaining its position relative to the cavity to be filled. Alternatively, the matrix band is utilized to retain the filling within the normal boundaries of the object tooth where it is generally spaced from the adjacent tooth.

Dental wedges are well known in the art and have been used in restorative dentistry for over a century. Generally, dental wedges are used to separate the teeth and hold a matrix band against the side of the tooth while a restoration is being placed. These functions are important for the successful restoration of the form and function of the tooth being restored. In particular, conventional dental wedges are utilized to provide support and placement of a matrix band or filling material mold. In use, a traditional wedge is inserted into the space between the adjacent teeth at the gum line and forced into the space to force separation of the teeth so that they may be restored. The amount of separation achievable with a wedge depends upon several factors. The interdental space present between the adjacent teeth and the size of the wedge are probably the most important of those factors.

Most commercially available dental wedges have been of the basic tetrahedral shape and made of various types of wood. To accommodate different sizes of interdental spaces, wedges are generally available in various sizes from small to large and the size used is determined by the size of the interdental space. These wedges achieve the requirement that the wedge be hard enough to allow the teeth to be driven apart. However, wooden wedges suffer from the problem of not conforming adequately to the interproximal surface of the tooth and from having a tendency to “back out” of the interdental space once having been placed. This tendency for the wedge to “back out” or not stay in its activated position tends to defeat the purpose of using the wedge in the first place. That is, if the wedge “backs out”, the separation of the teeth is lost and the matrix band is no longer supported against the side of the tooth, allowing for restorations with overhangs and poor interproximal contacts.

Another basic requirement of a dental wedge is that it be able to cause the matrix band to intimately conform to the anatomical surfaces of the tooth to be restored. Often, the interproximal surface of a tooth will be concave. Wherever a dental wedge does not intimately contact the flexible matrix band and force it against the concave surface of the tooth, the band is unsupported. In such a condition, a gap or opening will develop in response to the pressure of packing the restorative material into the matrix-confined cavity preparation. These gaps allow the filling material to push past the matrix and create a ledge, overhang, or an otherwise unacceptable contour of the tooth in the interdental space. Thus, rigid, fixed-shape wedges or wedge-type devices cannot adapt well to the variable contours of the interproximal spaces.

There have been varied attempts to compensate for a rigid, fixed-shape wedge design by incorporating convex contours into a polystyrene dental wedge, by using a thermoplastic coating on a lemon wood dental wedge, or by using various plastic formulations to create a dental wedge. None of these attempts have met the ideal criteria of providing both of the basic functions of a dental wedge, i.e., spreading the teeth and conforming the matrix band to the irregular contours of the side of the tooth.

Thus, most conventional wedges are difficult to use, cause discomfort or pain, and tend to damage the tissue of the gums. Further more, conventional dental wedges do not provide uniform force to the base of the matrix band. As a result, the wedge and matrix combinations of the past are deficient in providing an adequate seal with the tooth that is typically desired, in avoiding damage to the gum tissue, in providing a comfortable treatment for the patient. Also, it is well known in the field that the gap between two adjacent teeth at the gum line is typically not uniform in size and usually has a substantial inverted v-shape. The conventional dental wedge, as known in the art, is therefore inserted into this triangular or inverted v-shaped space in order to apply pressure at the base (gingival margin) of the matrix band. This advantageously allows the matrix band to properly conform to the natural shape of the tooth and seal the gingival margin of the cavity prior to placing the filling material into the cavity. Conventional dental wedges are usually inserted from one side of two adjacent teeth (tongue side or cheek side) and typically have a pointed configuration for ease of insertion. In particular, due to the tapered shape of the conventional dental wedge, when the dental wedge is inserted through the first side in the gap between two adjacent teeth, the force that is applied to the base of the matrix band is typically not uniform throughout the space between the two adjacent teeth. More force is applied to the base of the matrix band on the side of the point of insertion. Due to the physical size difference between different portions of the dental wedge, the tapered portion is unable to apply the same amount of force to the matrix band. As a result, the portions of the matrix band closest to the point of insertion for the dental wedge are typically pushed closer to the base of the tooth to be filled than those portions of the matrix band adjacent to the tapered end of the dental wedge. Accordingly, the filling material does not necessarily have the desired form fit and does not always conform to the natural contours of the patients tooth as desired.

Several inventors have proposed solutions to address these above-mentioned problems with conventional wedges. For example, U.S. Pat. No. 6,007,334 discloses a dental device comprising an elongated inflatable balloon for placement around a matrix band surrounding a decayed tooth. Upon inflation, the balloon evenly applies the matrix band against the tooth. However, this solution has problems of its own. For example, it is necessary to insert the matrix band prior to the balloon and the balloon is then inflated in order to apply force to the base of the matrix band and to conform the filling material to the desired contours of a patient's tooth. This process of inflating the balloon after inserting adjacent to the base of the matrix band in space between two adjacent teeth, is actually difficult to operate.

U.S. Pat. No. 5,527,181 discloses a one-piece dental wedge comprised of a rigid core and an elastic outer component which is capable of both separating adjacent teeth and conforming a matrix band to the irregular surfaces of a tooth being restored, and doing so without “backing out”. In order to conform the matrix band to the irregular contour of the side of the tooth, the wedge of the invention possesses elastic properties which enable it not only to recover from deformation but also “rebound” into the irregular contours of the side of the tooth. Although it appears that this design may provide more uniform force to the base of the matrix band, this design also appears to have several shortcomings. In particular, due to the tapered nature of this design, the amount of force applied by the dental wedge decreases progressively from a point closest to the point of insertion toward the tapered end of the dental wedge. Additionally, this dental wedge must be physically small and therefore may be difficult to work with when it is being initially inserted into the space between two adjacent teeth.

U.S. Pat. No. 6,074,210 discloses a dental wedge having a generally tetrahedron shaped body having a central longitudinal apex that is flanked by a pair of resilient sidewalls. Although the resilient sidewalls of this proposed dental wedge will provide more uniform force to a matrix band than conventional dental wedge designs, it still does not overcome all of the shortcomings of the prior art because it is both physically small and is of a tapered design that is inserted between teeth from one side only.

U.S. Pat. No. 6,890,176 discloses a dental apparatus adapted to facilitate formation of a filling in an object tooth and to retain the filling within normal boundaries of the object tooth and generally spaced from an adjacent tooth, including a thin sheet matrix for at least partially surrounding the object tooth and for fitting between the object tooth and the adjacent tooth, a wedge member connected to the matrix, and including a pair of wedges joined by a central segment, and at least a portion of the wedge member being formed of an elastomeric material. Here, only a portion of the wedge is elastic, hence the problems associated with inserting non-elastic wedge still exist. Secondly, the wedge is connected to the matrix, decreasing the ease of insertion between the teeth.

U.S. Pat. No. 6,435,874 discloses a dental wedge comprising a unitary body of elastic material that is stretched such that a central portion of the body of material is thinned. Although this provides a solution to the problems associated with most non-elastic dental wedges, there is still need to improve the design of the dental wedge so as to provide a thinner central portion requiring less stretching force and to offer ease of insertion of dental wedge especially in tightly spaced adjacent teeth.

### SUMMARY OF THE INVENTION

This invention is related to a dental device and methods of using this dental device. Specifically, this invention provides an elastic dental wedge for use in securing a matrix band or a cavity filling material mold against an object tooth. The dental wedge of the instant invention can be easily inserted and removed during dental treatment procedures.

In one embodiment, this invention provides an elastic dental wedge comprising an elongated elastic object having a first end, a central portion and a second end wherein the first end and the second end each have a grip; the central portion comprises a discontinuity decreasing the total amount of material in a cross-section of the object relative to a section adjacent to the discontinuity in the central portion; and the object can be stretched by applying force in opposite directions between the first end and the second end.

In another embodiment, this invention provides a method of inserting an elastic dental wedge between teeth comprising stretching the elastic dental wedge having a first end, central portion and a second end, wherein the first end and the second end each have a grip; the central portion comprises a discontinuity decreasing the total amount of material in a cross-section of the object relative to a section adjacent to the discontinuity in the central portion, by applying force in opposite directions between the first end and the second end and inserting the stretched elastic dental wedge between two adjacent teeth.

In another embodiment, this invention provides a method of separating two adjacent teeth apart in an orthodontic operation, wherein the method comprises stretching the elastic dental wedge having a first end, a central portion and a second end, wherein the first end and the second end each have a grip; the central portion comprises a discontinuity decreasing the total amount of material in a cross-section of the object relative to a section adjacent to the discontinuity in the central portion by applying force in opposite directions between the first end and the second end and inserting the stretched elastic dental wedge between two adjacent teeth.

In another embodiment, this invention provides a method for securing a matrix band or a cavity filling material mold against an object tooth, wherein the method comprises placing the matrix band or the cavity filling material mold against an object tooth stretching the elastic dental wedge having a first end, a discontinuous central portion and a second end, wherein the first end and the second end each have a grip; the central portion comprises a discontinuity decreasing the total amount of material in a cross-section of the object relative to a section adjacent to the discontinuity in the central portion, by applying force in opposite directions between the first end and the second end, inserting the stretched elastic dental wedge between the object tooth and an adjacent tooth next to the base of the matrix band or the cavity filling material mold, and removing the force between the first end and the second end resulting in the contraction and thickening of the central portion.

### DETAILED DESCRIPTION OF THE INVENTION

### Overview

The invention provides an elastic dental wedge that provides uniform support to a matrix band or cavity filling material mold in dental treatment procedures. The methods of using this elastic dental wedge are easy to operate and the unique design of the dental wedge offers easy insertion and removal.

### Definitions

“Discontinuity” as used herein refers to a break in the continuity of a material. In reference to a discontinuity in the central portion of an elastic dental wedge, discontinuity comprises decreased amount of elastic material in a cross-section of the central portion containing the discontinuity relative to a section adjacent to the discontinuity. Examples of a discontinuity include, but are not limited to, a hole, a notch, and a groove.

“Grip” as used herein refers to a handle, which comprises a physical change in the shape, texture or an attachment means that can be easily engaged by a tool or by hands. Examples of a grip include, but are not limited to, a depression, a hole, a knob, a cut, a texture and a malleable section.

### BRIEF DESCRIPTION OF THE DRAWINGS

FIG. 1 illustrates a top view of an elastic dental wedge of the instant invention.

FIG. 2 illustrates a top view of an elastic dental wedge of the instant invention stretched and inserted between two adjacent teeth.

FIGS. 3A, 3B, and 3C illustrate three alternate sizes of an elastic dental wedge of the instant invention.

FIGS. 4A, 4B, and 4C illustrate three alternate grips of an elastic dental wedge of the instant invention.

FIG. 5A illustrates a side view of an elastic dental wedge stretched and inserted between two adjacent teeth at the base of a matrix band.

FIG. 5B illustrates a side view of the filling material applied to the gap between a tooth and the matrix band with the dental wedge in its unstretched (rebounded) condition with its central portion expanded.

### An Elastic Dental Wedge of the Invention

In one embodiment, this invention provides an elastic dental wedge comprising an elongated elastic object having a first end, a central portion and a second end wherein the first end and the second end each have a grip; the central portion comprises a discontinuity decreasing the total amount of material in a cross-section of the object relative to a section adjacent to the discontinuity in the central portion; and the object can be stretched by applying force in opposite directions between the first end and the second end. In a further embodiment, the central portion is thinner than a portion near the first end and a portion near the second end.

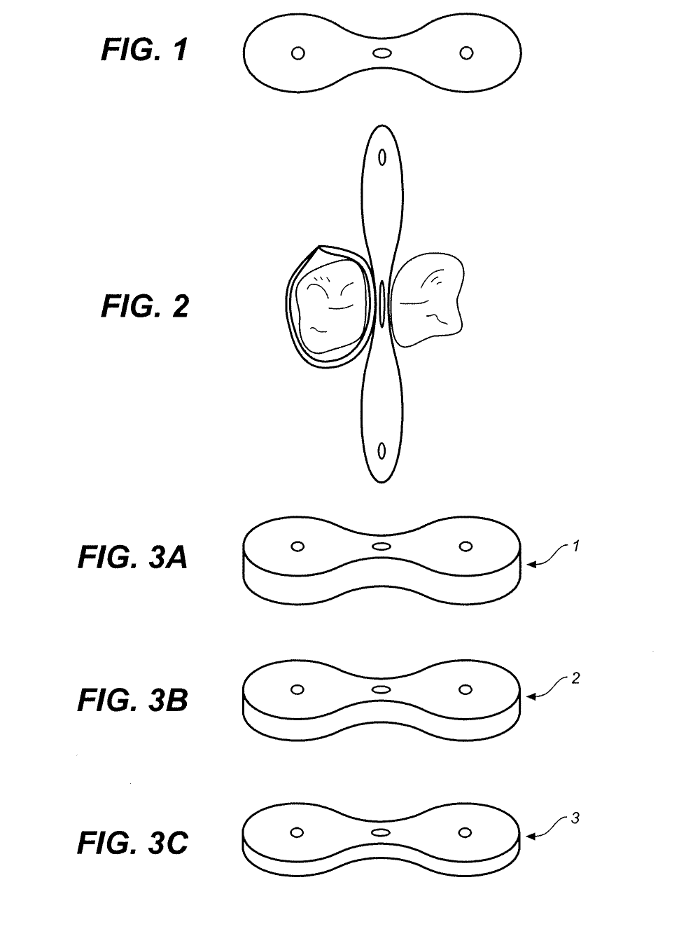

FIG. 1 illustrates a top view of an elastic dental wedge of the instant invention. The elastic dental wedge is made up of an elastic material that can be stretched by applying force in opposite directions between the first end and the second end. The elastic dental wedge can be stretched either by hand or by any instrument known in the art, for example, dental dam forceps. Those skilled in the art will recognize that other tools can also be used for stretching the wedge. FIG. 1 also illustrates the preferred shape for the wedge wherein the central portion having a discontinuity is located in the thinnest point of the wedge. The portions proceeding to the ends of the wedge become increasingly thicker. This design is preferred in order to provide more uniform force around the base of the tooth. Similarly, the central portion of the elastic dental wedge of the present invention has a discontinuity that makes the wedge thinner and easier to stretch. Those skilled in the art will recognize that it is not necessary to utilize such a shape and other configurations and designs will work for the intended purpose. Similarly, it is not necessary to include a tapered central portion. In particular, those skilled in the art will recognize that designs of uniform thickness for the wedge may be utilized as well. However, it is believed that improved results will be achieved by utilization of designs that conform or substantially conform to the natural contours of the shape between teeth when the wedge is in its relaxed state. Although the dental wedge shown in FIG. 1 is rectangular in cross-section, it should be recognized that other wedges that appear triangular, circular or trapezoidal in cross-section, can be similarly used.

Those of ordinary skill in the art will also recognize that by adjusting the physical characteristics of the wedge, other desired effects may be achieved, as described in greater detail below. Furthermore, it should be recognized that the devices and methods of the present invention may be utilized for securing devices other than matrix bands, e.g., dental dams, between teeth.

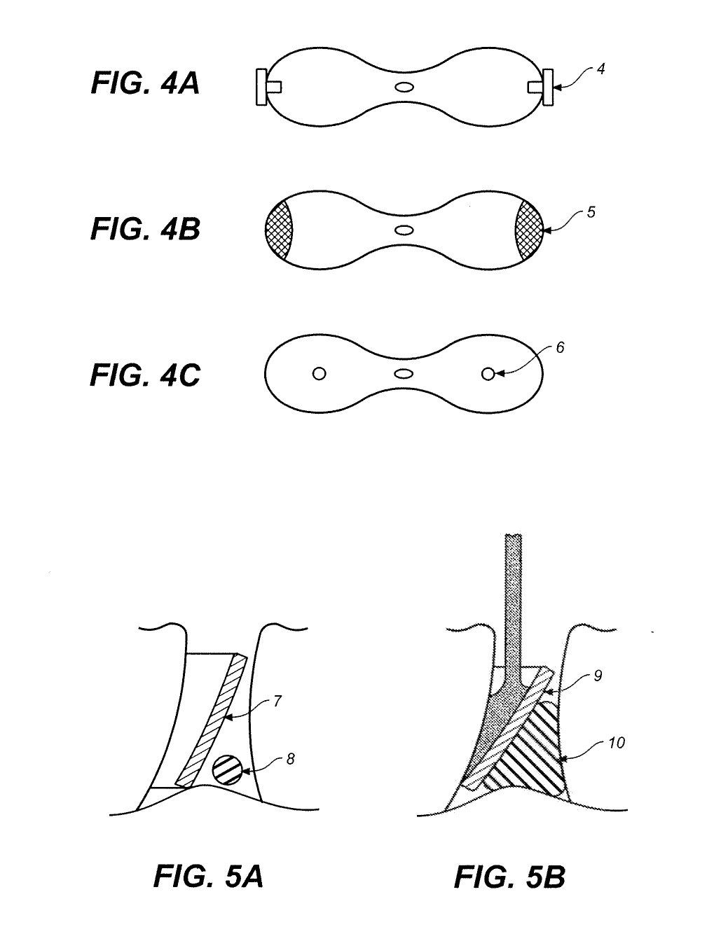

In another embodiment, this invention provides an elastic dental wedge comprising an elongated elastic object having a first end, a central portion and a second end wherein the first end and the second end each have a grip; the central portion comprises a discontinuity decreasing the total amount of material in a cross-section of the object relative to a section adjacent to the discontinuity in the central portion; and the object can be stretched by applying force in opposite directions between the first end and the second end, wherein, the grip is either a knob, textured, or a depression. In a further embodiment, the depression is a hole or is capable of receiving an instrument for stretching. FIGS. 4A, 4B, and 4C illustrate three alternate grips for an elastic dental wedge of the instant invention. In FIG. 4A, 4 being a knob; in FIG. 4B, 5 being a texture; and in FIG. 4C, 6 being a hole or depression. All three grips, a knob, a texture or a depression can be used for stretching with hands or by instrument.

In a preferred embodiment, the discontinuity in the central portion is a hole or a notch. Typically, the discontinuity in the central portion can correspond to the removal of about 25-75% material as seen in the cross-section relative to the cross-section of the area adjacent to the discontinuity. More preferably, the discontinuity can correspond to the removal of about 30-60% of the material. The hole in the central portion can be a circular hole or an oblong hole. In case of an oblong hole, it can be positioned such that the major axis of the oblong hole is parallel to the axis passing through the first and second ends. Alternatively, the oblong hole can be positioned such that the major axis of the oblong hole is approximately orthogonal to the axis passing through the first and second ends. Alternatively, the hole can be diamond shaped, star shaped, triangular, dumbbell shaped or the like.

FIG. 2 illustrates a top view of an elastic dental wedge of the instant invention stretched and inserted between two adjacent teeth. Typically, the elastic dental wedge is stretched holding the grips in the first end and the second end of the wedge using a dental tool or by hands, resulting in thinning of the central portion so that it can be easily inserted in the space between two adjacent teeth next to the base of a matrix band or a cavity filling material mold. The discontinuity in the central portion helps in thinning the central portion significantly and allows quick and easy insertion between closely spaced adjacent teeth. The discontinuity also decreases the distance/force of stretching required to achieve thinness necessary to pass between closely spaced teeth. After the wedge has been inserted into the space between two adjacent teeth next to the base of the matrix band or cavity filling material mold, the force which has been applied to the opposite ends of the wedge is then removed. As a result, the previously stretched wedge contracts and becomes thicker in its central portion having the discontinuity, which had been previously thinned. The contraction and thickening of the wedge in the space between adjacent teeth fills this space and applies an outward force to the walls of this cavity. Accordingly, the contracted wedge applies a force on the base of the matrix band or cavity filling material mold which forces the base of the matrix band or filling material mold adjacent to the base of the tooth to be filled. Due to the physical shape and characteristics of the wedge, when placed between teeth adjacent to a matrix band, a more uniform application of force to the matrix band is achieved than the force applied by prior art devices. Additionally, the discontinuity in the wedge helps in easy insertion between very closely spaced adjacent teeth.

Once the wedge has been expanded and the matrix band is pressed against the side of the tooth to be filled, the dentist simply performs the normal cavity filling procedure which is well known in the art. The cavity filling material conforms to the side wall of the tooth as desired due to the proper placement of the matrix band or filling material mold. The more uniform application of force which is possible through the use of the wedge of this invention provides the proper form fit of the filling material to a patient's tooth.

In another embodiment, this invention provides an elastic dental wedge comprising a rubber, silicone, latex, polystyrene, polyamide or polyurethane. In a preferred embodiment, it comprises a thermoplastic elastomer (TPE) or natural rubber. In a further embodiment, it comprises polyurethane. In a further embodiment, the elastic dental wedge comprises a polyurethane known as “Pellethane”. The use of elastic or any deformable material overcomes most problems associated with non-elastic conventional dental wedges and also makes the insertion and removal of the wedge quick and easy. The relative elasticity and rebounding strength of a material is reflected in its hardness. Durometer is one of several ways to indicate the hardness of a material, defined as the material's resistance to permanent indentation. There are several scales of durometer, used for materials with different properties. The two most common scales, using slightly different measurement systems, are the A and D scales. As used herein, all measurements of durometer refer to measurements utilizing the A scale. In a preferred embodiment, the elastomieric material of the dental wedge has a durometer of between about 40 and about 80. More preferably, the durometer ranges between about 50 and about 70. Most preferably, the durometer is about 60. One of ordinary skill in the art will recognize that certain applications of the dental wedge of the invention will be better achieved using elastomeric materials of greater or lesser hardness. For example, use of the dental wedge in orthodontic applications, as described in greater detail below, may benefit from utilizing a wedge having a durometer of between about 60 and about 80, i.e., a harder material, which might result in faster and more sustained separation of teeth as compared to using a softer material.

The desirable characteristics of the material for dental wedge of the present invention include elasticity, resilience or rebound. Ideally, any material that can be easily stretched and that is capable of recovering its size and shape after deformation, will be suitable for the dental wedge. Polyurethane, for example, Pellethane, is currently used in dental field for the formation of elastomeric ties or orthodontal elastomeric modules. A particularly preferred material for use in manufacturing the dental wedge of the invention is a styrene ethylene/butylene styrene block copolymer (SEBS). Such co polymers are available under the trade name C-flex from Consolidated Polymer. It should be recognized, however, that other materials, particularly any thermoplastic elastomer, may be suitable as well. Such materials can be acquired from Rocky Mountain Orthodontics, Inc. of Denver Colo., Ortho Organizers of San Marcos Calif., or Dow Chemical Company. It is contemplated that the material will be specifically molded to the shape and physical configuration of the dental wedge. Alternatively, existing dental ligatures or other products made from this material may be trimmed or otherwise processed into the desired shape for these products.

FIGS. 3A, 3B, and 3C illustrate a top view of three alternate sizes of an elastic dental wedge of the instant invention. In FIG. 3A, 1 indicates a thickness of 3.2 mm; in FIG. 3B, 2 indicates a thickness of 2.6 mm, and in FIG. 3C, 3 indicates a thickness of 2 mm. Each of the designs of FIGS. 3A, 3B, and 3C includes holes in the opposite ends and in the central portion of the wedge. As noted above, the holes in the opposite ends are used by the stretching tool or hands for engaging the ends of the wedge. The hole in the central portion plays key role in thinning the wedge after stretching, resulting in easy insertion between the adjacent teeth. The alternate sizes that correspond to varying thickness of the dental wedges can be utilized when filling different sized teeth. Those skilled in the art will recognize that the size of patient's teeth varies as well as the corresponding gap between two adjacent teeth, also referred to as interproximal condition. Accordingly, dental wedges of various sizes have been historically utilized in order to properly fit the various sized gaps between patient's teeth. The instant invention provides an elastic dental wedge, wherein the thickness of the dental wedge, as shown in FIGS. 3A, 3B, and 3C, is approximately about 1-5 mm in an unstretched state. In one embodiment, the thickness of the dental wedge is approximately about 2 mm in an unstretched state. In another embodiment, the thickness of the dental wedge is approximately about 2.6 mm in an unstretched state. In yet another embodiment, the thickness of the dental wedge is approximately about 3.2 mm in an unstretched state. One of these 3 sizes will adapt to almost all interproximal conditions. Thus, adaptability to different teeth sizes and different interproximal conditions, is one of the key features of the elastic dental wedge of the instant invention.

### Methods of Using an Elastic Dental Wedge of the Invention

The instant invention provides a method of inserting an elastic dental wedge between teeth comprising stretching the elastic dental wedge having a first end, a central portion and a second end, wherein the first end and the second end each have a grip; the central portion comprises a discontinuity decreasing the total amount of material in a cross-section of the object relative to a section adjacent to the discontinuity in the central portion, by applying force in opposite directions between the end first end and the second end and inserting the stretched elastic dental wedge between two adjacent teeth. In a further embodiment, the method further comprises stretching the elastic dental wedge with a stretching tool. In another embodiment, the method comprises stretching the elastic dental wedge with hands. The discontinuity in the central portion significantly decreases the amount of material that must pass between the teeth at their closest contact. This helps in quick and easy insertion of the dental wedge even in closely spaced adjacent teeth.

FIG. 5A is a side view which illustrates the tooth and matrix band sidewall 7 with the elastic dental wedge 8 of the present invention inserted in the space between two adjacent teeth. In this view the wedge is in its extended condition with its central portion thinned. This view illustrates the dental wedge before the stretching force has been removed subsequent to insertion of the wedge of the present invention in the space between two adjacent teeth. FIG. 5B illustrates the filling material being applied to the gap between the matrix band 9 and the tooth. The dental wedge 10 preferably has a triangular or tetrahedron shape in the central portion of the collapsed form, thereby providing uniform application of force to the matrix band material when it expands in the gap between two adjacent teeth. This preferred shape provides the desired form fit for the matrix band thereby providing the preferred application of force to the matrix band.

This invention also provides a method of separating two adjacent teeth apart in an orthodontic operation, wherein the method comprises stretching the elastic dental wedge having a first end, a central portion and a second end wherein the first end and the second end each have a grip; the central portion comprises a discontinuity decreasing the total amount of material in a cross-section of the object relative to a section adjacent to the discontinuity in the central portion, by applying force in opposite directions between the end first end and the second end and inserting the stretched elastic dental wedge between two adjacent teeth. The insertion of stretched wedge of the present invention is useful for creating a space between teeth. Separation of the teeth enables a practitioner to easily carry out the orthodontic operation procedures, for example, positioning a matrix band around a tooth or inserting a dental appliance such as diamond blade to file a tooth for interproximal reduction, etc. The wedge remains in place for a period of time sufficient to reduce rebounding of the teeth to their original position. Typically, it can remain in place from about 30 seconds to about 24 hours, preferably from about 30 seconds to about 5 minutes and more preferably from about 1 minute to about 2 minutes. One skilled in the art will know that this time can vary depending on the type of procedure used.

This invention also provides a method for securing a matrix band or a cavity filling material mold against an object tooth, wherein the method comprises placing the matrix band or the cavity filling material mold against an object tooth and stretching the elastic dental wedge having a first end, a central portion and a second end, wherein the first end and the second end each have a grip, the central portion comprises a discontinuity decreasing the total amount of material in a cross-section of the object relative to a section adjacent to the discontinuity in the central portion, by applying force in opposite directions between the first end and the second end and inserting the stretched elastic dental wedge between the object tooth and an adjacent tooth next to the base of the matrix band or the cavity filling material mold and removing the force between the first end and the second end resulting in the contraction and thickening of the central portion.

The stretched wedge with the thinned central portion containing the discontinuity is easily inserted in the space between two adjacent teeth next to the base of a matrix band or cavity filling material mold. After the wedge is inserted into the space between two adjacent teeth next to the base of the matrix band or cavity filling material mold, the force which has been applied to the opposite ends of the wedge is then removed. As a result, the previously stretched wedge contracts and becomes thicker in its central portion that had been previously thinned. The contraction and thickening of the wedge in the space between adjacent teeth fills this space and applies an outward force to the walls of this cavity. Accordingly, the contracted wedge applies a force on the base of the matrix band or cavity filling material mold which forces the base of the matrix band or filling material mold adjacent to the base of the tooth to be filled. Due to the physical shape and characteristics of the wedge, when placed between teeth adjacent to a matrix band, a more uniform application of force to the matrix band is achieved. In a further embodiment, the matrix band is a Tolfemire matrix band or a sectional matrix band. In a further embodiment, the method further comprises placing a matrix ring on the matrix band. It is noteworthy that the dental wedge of the instant invention works well with all types of matrix systems.

This invention also provides a method for securing a dental dam, the method comprising placing a dental dam over teeth and at the gumline, stretching an elastic dental wedge having a first end, a central portion and a second end, wherein the first end and the second end each have a grip, the central portion comprises a discontinuity decreasing the total amount of material in a cross-section of the object relative to a section adjacent to the discontinuity in the central portion, by applying force in opposite directions between the first end and the second end, inserting the stretched elastic dental wedge between adjacent teeth and on top of the dental dam at the gumline, thereby securing the dental dam in place.

This invention also provides a method for tooth restoration, wherein the method comprises placing a matrix band or a cavity filling material mold against an object tooth, stretching an elastic dental wedge having a first end, a central portion and a second end, wherein the first end and the second end each have a grip, the central portion comprises a discontinuity decreasing the total amount of material in a cross-section of the object relative to a section adjacent to the discontinuity in the central portion, by applying force in opposite directions between the first end and the second end, inserting the stretched elastic dental wedge between the object tooth and an adjacent tooth next to the base of the matrix band or the cavity filling material mold, removing the force between the first end and the second end resulting in the contraction and thickening of the central portion, placing a restorative material on the object tooth, removing the elastic dental wedge by cutting, and removing the matrix band or the cavity filling material mold. A stepwise tooth restoration process can be carried out using an elastic dental wedge of the instant invention. In a typical tooth restoration process, in the first step, the wedge is stretched using a dental tool or by hands holding the grips in the first end and the second end of the wedge. In the next step, a matrix band is placed around the tooth to be restored followed by the stretched wedge between the object tooth and the adjacent tooth. In the next step, a ring is placed above or behind the wedge and restorative material is applied. After the procedure is complete, in the next step, the ring and the wedge are removed. For the removal of the wedge, the dentist or other person performing the procedure simply applies an outward force on the opposite ends of the wedge. Due to the application of this outward force, the central portion of the wedge becomes thinner and thus may be easily removed by cutting either the tongue side or cheek side of wedge when stretched. The two separate portions of the wedge are then recovered and removed from the space between two adjacent teeth. This may be accomplished even when a matrix band or filling material mold is present. Alternatively, the wedge may be removed simply by stretching thereby allowing the central portion having the discontinuity to become thinner for ease of removal. Thus, the removal of dental wedge is a fast and easy process. The matrix band or filling material mold is then subsequently removed as in any other conventional cavity filling procedure. Finally, the tooth is finished and polished and restored with its natural contours.

With the proper wedge size selection from the alternate sizes shown in FIG. 3, the elastic dental wedge of the instant invention can be used for both Class II and Class III tooth restorations. The form and elastic qualities of the wedge allow simultaneous wedging of interproximal matrix from both labial and lingual aspects, securing the matrix, separating the teeth and sealing the gingival margin. It also assists in providing ideal inter-proximal contours and contacts. This invention provides a simple, uniquely designed, easy to use elastic dental wedge that assures fast placement, compatibility with all interproximal matrix systems and reliable gingival adaptation.

Various modifications and variations of the described device and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An elastic dental wedge comprising an elongated elastic object having a first end, a central portion and a second end wherein the first end and the second end each have a grip; the central portion comprises a discontinuity decreasing total amount of material in a cross-section of the object relative to a section adjacent to the discontinuity in the central portion; and the object can be stretched by applying force in opposite directions between the first end and the second end.

2. The elastic dental wedge of claim 1, wherein the central portion is thinner than a portion near the first end and a portion near the second end.

3. The elastic dental wedge of claim 1, wherein the grip is a knob.

4. The elastic dental wedge of claim 1, wherein the grip is textured.

5. The elastic dental wedge of claim 1, wherein the grip is a depression.

6. The elastic dental wedge of claim 5, wherein the depression is capable of receiving an instrument for stretching.

7. The elastic dental wedge of claim 5, wherein the depression is a hole.

8. The elastic dental wedge of claim 1, wherein the discontinuity comprises a hole or a notch.

9. The elastic dental wedge of claim 1, wherein the elastic dental wedge comprises a thermoplastic elastomer or rubber.

10. The elastic dental wedge of claim 9, wherein the thermoplastic elastomer is a styrene ethylene/butylene styrene block co-polymer or a polyurethane.

11. The elastic dental wedge of claim 1, wherein the thickness of the dental wedge is approximately about 1-5 mm in an unstretched state.

12. The elastic dental wedge of claim 1, wherein the thickness of the dental wedge is approximately about 2 mm in an unstretched state.

13. The elastic dental wedge of claim 1, wherein the thickness of the dental wedge is approximately about 2.6 mm in an unstretched state.

14. The elastic dental wedge of claim 1, wherein the thickness of the dental wedge is approximately about 3.2 mm in an unstretched state.

15. A method of inserting an elastic dental wedge between teeth comprising:
stretching the elastic dental wedge of claim 1 having a first end, a central portion and a second end by applying force in opposite directions between the first end and the second end; and
inserting the stretched elastic dental wedge between two adjacent teeth.

16. The method of claim 15, wherein the method further comprises stretching the elastic dental wedge with a stretching tool.

17. The method of claim 15, wherein the method further comprises stretching the elastic dental wedge with hands.

18. A method of separating two adjacent teeth apart in an orthodontic operation, wherein the method comprises:
stretching the elastic dental wedge of claim 1 having a first end, a central portion and a second end by applying force in opposite directions between the first end and the second end; and
inserting the stretched elastic dental wedge between two adjacent teeth.

19. A method for securing a matrix band or a cavity filling material mold against an object tooth, wherein the method comprises:
placing the matrix band or the cavity filling material mold against an object tooth;
stretching the elastic dental wedge of claim 1 having a first end, a central portion and a second end by applying force in opposite directions between the first end and the second end;
inserting the stretched elastic dental wedge between the object tooth and an adjacent tooth next to the base of the matrix band or the cavity filling material mold; and
removing the force between the first end and the second end resulting in the contraction and thickening of the central portion.

20. The method of claim 19, wherein the matrix band is a Tolfemire matrix band or a sectional matrix band.

21. The method of claim 19, wherein the method further comprises placing a matrix ring on the matrix band.

22. A method for tooth restoration, wherein the method comprises:
placing a matrix band or a cavity filling material mold against an object tooth;
stretching an elastic dental wedge of claim 1 having a first end, a central portion and a second end by applying force in opposite directions between the first end and the second end;
inserting the stretched elastic dental wedge between the object tooth and an adjacent tooth next to the base of the matrix band or the cavity filling material mold;
removing the force between the first end and the second end resulting in the contraction and thickening of the central portion;
placing a restorative material on the object tooth;
removing the elastic dental wedge by cutting; and
removing the matrix band or the cavity filling material mold.
